(19) United States
(12) Patent Application Publication
(10) Pub. No.: US 2020/0231511 A1
(43) Pub. Date: Jul. 23, 2020

(54) CARBON DIOXIDE MEDIATED RECOVERY OF POTASSIUM COMPOUNDS FROM BRINES

(71) Applicants: Krishnamohan Sharma, Milpitas, CA (US); Tanuja KOSURI, SECUNDERABAD (IN)

(72) Inventors: Krishnamohan Sharma, Milpitas, CA (US); Tanuja KOSURI, SECUNDERABAD (IN)

(21) Appl. No.: 16/313,897

(22) PCT Filed: Oct. 25, 2016
(86) PCT No.: PCT/IN2016/000257

§ 371 Date: Dec. 28, 2018

(30) Foreign Application Priority Data
Sep. 7, 2016 (IN) 201641030523

(51) Int. Cl. C05D 1/00; C02F 9/00; C05D 9/02; C05G 1/00

(52) U.S. Cl. CPC C05D 1/00; C02F 9/00; C02F 1/42; C05G 1/00; C05D 9/02

(57) ABSTRACT

The present invention is related to methods for recovering high purity potassium based salts from brine using carbon dioxide as one of the major consumables. The method of the present invention is zero waste/effluent method which can be effectively used for the preparation of customized fertilizer compositions containing primary, secondary and micro-nutrients, and optionally other chemicals necessary for healthy growth of crops.

### CROSS-REFERENCE TO RELATED APPLICATIONS

The present application is a continuation of an International Application Number PCT/IN2016/000257, with a filing date of Oct. 25, 2016, the entire disclosure of which is incorporated herein by reference for all purposes. The present application claims the benefit of foreign priority application number 201641030523, with a filing date of Sep. 7, 2016, filed at the Patent Office of Government of India, the entire disclosure of which is incorporated herein by reference for all purposes.

### FIELD OF INVENTION

The present disclosure relates generally to generating useful potassium compounds from brines such as seawater or salt solution containing potash minerals.

### BACKGROUND OF THE INVENTION

The world population is expected to increase from current 6.7 billion to 9.2 billion by 2050, and may incur enormous pressure on global natural resources. The demand for food and clean water will go up by 50% or more in the next 30 years. However, unfortunately, the arable land is limited and rapidly shrinking with urbanization; the clean water supplies are dwindling; around 1.8 billion people across the globe are already stressed for clean water. Therefore, there is a need for new and improved ways to significantly reduce the desalination costs to supply clean water to majority of the population at affordable cost. A major technological revolution may also be needed to dramatically improve the yield of the crops, with the fertilizing formulations tailor made to retain the long-term health of soil while meeting the individual plant/crop nutritional needs.

The natural resources of fertilizing chemicals (Nitrogen, N; Phosphorous, P; Potash, K) and clean water are limited to few regions and countries. For example, fertilizing chemical sources are concentrated in select few countries (e.g., Potassium in Canada, Belarus, and Russia; Phosphorous in Morocco, Jordan, China and USA), and only 1 out of every 10 persons in the world population have ready access to fresh water. About 95% of water resources on the planet are in oceans, and seawater has 100,000 times more Potash, an important fertilizing chemical, than on the land. Besides, seawater also contains other useful fertilizing chemicals and minerals such as sulfur, magnesium, calcium, sodium, boron, chloride, manganese, iron, nickel, copper, zinc, molybdenum, and lithium. Probably, seawater is the only natural resource that is widely available and accessible to several countries across the globe. Indeed, the most water stressed and agriculture dependent regions in the world are not too far from seashore (e.g., Southern and Western States of India; California, Texas and Florida of USA; Zhuhai, Rizhao, Qingdao, Xiamen, Sanya of China). Therefore, tapping the seawater can be considered as an alternative to meet the local demand for clean water and fertilizers to effectively reduce the cost of desalination and production of fertilizers. Further advantages may include savings on foreign exchange, prevention of unnecessary mining, and decreased use of resources for transportation. One major objective of this disclosure is to extract high purity potassium minerals and related fertilizers from brines, preferably in conjunction with seawater desalination or distillery plants.

Potassium (or pot ash, or K) is one of the three important primary fertilizing chemicals, and is known to protect crops against diseases, improve water retention, yield, nutrient value, taste and texture. Conventionally, potash is recovered from ores such as sylvinite, sylvite, carnalite, kainite, polyhalite, langbeinite, schoenite. However, its recovery requires complex and environmentally unfriendly mining techniques such as underground mining and solution mining followed by series of milling processes such as desliming (crushing and grinding), floatation, drying and sizing, which may lead to release of radioactive nucleotides, dust and metals, carbon emissions, erosion of land and habitat, depletion of local fresh water supplies. At present, almost 100% of potash is mined cheaply in the form of KCl (muriate of potash) from brines, unlike historic methods of making it by burning the wood. The word potash comes from the Middle Dutch word potaschen (pot ashes), which is a 16^{th} century method of making potassium carbonate (K₂CO₃), where wood ashes were leached and evaporated and the left over white residue was called as pot ash.

Muriate of potash, KCl, has a higher salt index, 120, and is most commonly contaminated with sodium chloride (salt indexes of some commonly used potassium minerals is shown in Table 1). The salt index is defined as the ratio of the increase in osmotic pressure of the soil solution produced by the fertilizer to that produced by the same mass of sodium nitrate. Typically, salts with higher salt index inhibit seed germination and sprouting, or causes scorching, and foliar burn. Some of the visible symptoms include slow and spotty seed germination, sudden wilting, stunted growth, marginal burn on leaves (especially lower, older leaves), leaf yellowing, leaf fall, dead roots, restricted root development, and sudden or gradual death of plants. The soil containing higher salts may exhibit “salt injury”, although, the roots are unaffected by excess salts, the soluble salts enter the roots and are moved through the plant vessels to the leaves where the water evaporates and gradually concentrates the salts to toxic levels that harm the plants. The presence of sodium chloride in soil has been shown to hinder the plant development as it affects the osmoregulation, inactivates the enzymes involved in protein synthesis, effects photosynthesis, and causes calcium leakage from the cell membrane. Therefore, the higher salt index of KCl could potentially lead to salt injury and may disrupt the osmotic gradient in the soil rhizophere and the soil microorganisms that are vital for healthy soil function. The usage of KCl needs to be carefully tailored to the plant growth stage and soil health objectives. Also, the plants normally consume smaller amounts of chloride and the residual chlorides are reported to alter soil pH and cause salinity problems that may adversely affect plant growth.

TABLE 1

| Potassium Mineral | Salt Index |
|---|---|
| Potassium Chloride | 120.1 |
| Potassium Nitrate | 69.5 |
| Potassium Thiosulfate | 68 |
| Potassium Sulfate | 42.6 |
| Potassium Carbonate | 20 |
| Potassium Citrate | 10 |
| Monopotassium Phosphate | 8.4 |

Potash fertilizers in the form of potassium nitrate, potassium thiosulfate, potassium sulfate, potassium carbonate, potassium citrate, mono potassium phosphate are considered safe for plants and soil as they have relatively low salt indexes, and are preferred forms of potash fertilizers, especially as fluids or liquids to prevent foliar burn, low seed germination issues or seedling injury. However, majority of the low salt index potassium salts are expensive as they are produced from KCl through various chemical and electrolytic reactions/transformations. Consequently, potash in the form of KCl is being used indiscriminately in the developing countries in lieu of preferred low salt index materials, inadvertently impacting the yields and long term soil health. Therefore, one of the objectives of this disclosure is to recover low salt index potassium salts with low or no sodium chloride contamination directly from natural resources.

Many of the earlier efforts to recover useful potassium salts from the seawater in a pure form seem to have failed for a variety of technological, environmental and economic reasons. For example:

U.S. Pat. No. 3,429,657 describes the method of producing potash salts from the brines of the mineral salts containing NaCl, KCl and MgCl₂ using fractional crystallization. The potash salts were recovered by precipitating potassium perchlorate (KClO₄), by adding sodium perchlorate to the brine solution and passing the recovered KClO₄ solution through a resin to separate K ions from perchlorate ions and combining K with varied anions to generate different potash salts. However, potassium in perchlorate form is not useful for any fertilizing needs or commercial applications. Indeed it is detrimental to the environment, and its presence in water even at ppm or ppb levels could be harmful to both human and oceanic life forms. Further, conversion of potassium perchlorates safely into other useful forms of potassium makes the entire process prohibitively expensive.

Chinese publication CN102976797 discloses a method of extracting potassium liquid salt production from seawater using Clinoptilolite as an ion exchanger. The method also includes absorption of other elements such as bromine, magnesium, calcium and the like. Saturated ammonium chloride solvent was used as an eluent solution. The final potash salt solution contains significant amounts of ammonium chloride and is contaminated with sodium chloride. Thus this patent also failed to extract potassium chloride in pure form from seawater.

WO2015016607A1 describes a method for the extraction of KCl and K₂SO₄ from a concentrated brine solution after extraction of Li, Mg, and Ca. It describes an apparatus that is resistant to a high salinity solution and works on the liquid-solid separation method where lithium, magnesium and calcium are separated in the first step. The KCl is recovered in the potassium recovery apparatus that separates it from the mixed salts (lithium, magnesium and calcium) and also from glaserite. It also describes a continuous potassium sulfate conversion apparatus for extraction of potassium sulfate from the glaserite. The process reported is yet another modified way of recovering high salt index KCl as a final product, like several other potassium conventional mining methods.

U.S. Pat. No. 7,014,832 B2 discloses a process that recovers industrial grade potassium chloride and low sodium edible salt (mixture of chlorides of both sodium and potassium) from seawater bitterns. The bittern is desulfated using calcium chloride and the solution is concentrated in solar pans to reach a specific gravity of >1.28 that crystallizes unwanted sodium chloride without significant loss of potassium chloride. The filtered bittern has 60% of KCl, which is obtained in salt form by forced evaporation. Although, the process described is somewhat different and deviated from conventional potassium mining methods, the final product generated is in the form of high salt index, KCl, like other conventional mining methods.

As discussed above, many of the potassium recovery methods in the prior art target to recover it as a muriate of potash (KCl) from natural resources using a variety of processes and methods. The low salt index potassium salts seem to be generated by converting KCl recovered from natural resources, with the exception of some historic methods of recovering potassium carbonate from wood ashes. For example, U.S. Pat. No. 6,315,976 describes the generation of potassium sulfate (salt index 42.6) from potassium chloride through a double displacement reaction, where KCl was reacted with ammonium sulfate at 30-40° C. The double salt obtained is made to react with a slurry of potassium chloride to produce potassium sulfate crystals through solid/liquid separation. Similarly, U.S. Pat. No. 4,342,737 envisages the reactions between potassium chloride and sulfuric acid to obtain potassium sulfate and hydrochloric acid as the products. U.S. Pat. No. 7,601,319 B2 describes a process of producing monobasic potassium phosphate by combining phosphoric acid and potassium hydroxide. U.S. Pat. No. 5,449,506 discloses a method of converting potassium chloride into potassium carbonate (salt index 20) by using a continuous countercurrent exchange system using concentrated potassium chloride solution isolated from conventional mining methods.

Methods of generating potassium based fertilizers, such as NK, NPK, PK, NKS, NPKS using seawater reject as a feed are described in WO 2016025109 A1; however the methods do not involve recovering highly pure potassium salt solutions such as potassium carbonate, potassium sulfate, potassium chloride, potassium phosphate rich solutions and processing the solutions as described herein.

As can be seen from the above and several other examples in the literature, potassium is mostly recovered in the form of KCl from natural resources and is further converted into various low salt index forms of potassium through additional processing methods. One objective of the present disclosure is to directly recover low salt index potassium minerals from the natural resources, such as potassium carbonates (referred to represent K₂CO₃, or KHCO₃ or their combination), potassium sulfate, etc. cost effectively and to further convert them into valuable potassium forms through simple chemistry using carbon dioxide as one of the key chemical ingredients. The methods described herein provide easier and less expensive ways to directly produce or convert potassium carbonate into other forms of low index potassium salts than from potassium chloride.

In addition most of the efforts to recover pure low salt index potassium salts from seawater for fertilizing purposes have largely been unsuccessful as they are either contaminated or generated as an insoluble precipitate with little or no commercial utility. Further, many of the low salt index potassium minerals/fertilizers use potassium chloride mined from conventional methods as a raw source. The methods described herein provide improved and innovative methods for recovering a variety of potassium based salts from a brine source using carbon dioxide as a recovery agent. Conversely, potassium ions in the brine could be viewed as recovery agents to trap carbon dioxide from the environment.

### OBJECTIVE OF THE PRESENT INVENTION

The principal objective of the present invention is to provide a method for recovering a variety of high purity potassium based salts from brine using carbon dioxide as one of the major consumables.

Another object of the invention is to provide a process with zero waste/effluent and generation of customized fertilizer compositions.

### SUMMARY OF THE DISCLOSURE

The present invention relates generally to methods for recovering a variety of high purity potassium based salts from brine using carbon dioxide as one of the major consumables. Further, the proposed innovation reveals a process with zero waste/effluent and generation of customized fertilizer compositions containing primary, secondary and micronutrients and optionally other chemicals necessary for healthy growth of crops.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a process flow diagram of seawater desalination reject used for selectively extracting potassium in accordance with some embodiments.

FIG. 2 is a process flow diagram for the generation of high purity potassium materials in accordance with some embodiments.

FIG. 3 is a process diagram for recovery, regeneration and recycling of process streams during the recovery of potassium materials in accordance with some embodiments.

FIG. 4 is a process flow diagram for concentrating a solution of high purity potassium materials recovered from seawater in accordance with some embodiments.

### DETAILED DESCRIPTION

Potassium (K) is one of the key ingredients of three primary fertilizing chemicals, NPK. The potash natural resources are concentrated in about 10 countries, Canada, Belarus, Russia, Germany, Jordan, and Israel just to name a few. On the other hand, over 150 countries import potash, primarily to meet their fertilizer needs. However, just handful of countries such as USA, China, India, Brazil, Indonesia, and France, import over 70% of the potash produced worldwide.

Many of the potash importing countries are surrounded by oceans, which contain 100,000 times more potash than on land; unfortunately, at present there are no cost effective technologies to recover potash from seawater. Indeed, many of the potassium importing countries (along with several others) are plagued by clean water shortage as well, and these countries may look to seawater desalination technologies as a way to address the domestic clean water needs. For example, one of the biggest desalination plants in the USA was recently opened in Carlsbad, California, USA Similarly, Chennai, Tamil Nadu, India has one of the India's biggest seawater desalination plants. Although, efforts to reduce the cost of desalination has led to tremendous advances such as modern reverse osmosis (RO), forward osmosis (FO), advanced vapor compression desalination (VCD) technologies, they are still considered expensive even for developed nations. In addition the economy of scale is not in favor of smaller desalination plants. In this regard, it was discovered that generating value from seawater reject of desalination plants offers enormous additional value and may lower the overall cost of producing potable water and fertilizers. Further, the proposed invention could be used to recover potassium from several types of potassium containing brine solutions, including waste stream from distilleries.

Although, several attempts have been made to recover potassium from seawater, many of them were by and large unsuccessful for environmental or technical or economic reasons. The methods of the present invention involve the extraction of potassium from seawater in the form of potassium carbonate using carbon dioxide as one of the key inputs. Other chemicals used in the process can be recycled, leaving seawater or salt water and carbon dioxide as net major consumables. The ability to recycle many process streams makes the processes described herein environmentally beneficial as harmful waste products are not typically generated and discarded as waste. For example, portions of the brine solutions produced herein can be recycled or discarded in the ocean or combined with other brine sources. The method of the present invention is hence a zero-waste or zero effluent process.

One major advantage of this approach is that potassium can be recovered as potassium carbonate or potassium bicarbonate or potassium sulfate or potassium phosphate and other potassium based salts directly as opposed to current means of recovering potassium in the form of potassium chloride. Unlike potassium chloride, potassium carbonate has a low salt index, and can be readily converted into other useful forms of potassium minerals as described herein. For example, converting potassium chloride into potassium carbonate, potassium phosphates, potassium nitrate, potassium citrate etc. is quite expensive because potassium chloride needs to be first mined, purified and converted into potassium hydroxide, which can include using an energy intensive electrolysis process that requires a high purity KCl solution as a feed, prior to additional processing steps. On the other hand, potassium carbonates can be directly reacted with acids to form corresponding potassium salts while evolving carbon dioxide as a gas. Potassium hydroxide can be generated by heating potassium carbonates at a desired pH and/or at elevated temperatures. Further, potassium carbonate can also be treated with raw minerals of phosphorous, such as calcium phosphates, to generate insoluble calcium carbonate and soluble potassium phosphate. The calcium carbonates generated could be heated to be converted into lime and carbon dioxide, both of which can be advantageously used in the process to generate ammonia or to recover ammonia or potassium as ammonium and potassium carbonates, respectively.

Potassium carbonate can also be readily converted into various useful forms of liquid fertilizers such as NK, NPK, NKS, KP, NPKS with appropriate organic or inorganic counter anions, easily and less expensively, than the KCl based processes. The use of carbon dioxide enables the recovery of potassium in any targeted salt form, KₙX⁻ⁿ, wherein n represents the net charge of anion, X; X is any organic or inorganic anion, for example, X=halides, borates, oxides, phosphonates, phosphates, carboxylates, sulfates, sulfonates, carbonates, SO₄, SO₃, PO₄, H₂PO₄, HPO₄, OH, SiO₄, NO₃, CO₃, HCO₃, BF₄, CH₃COO, R—PO₃, R—COO, R—SO₃, HSO₄, SO₃, and R=organic moiety. Improved methods of making various potassium minerals directly from natural resources are described herein.

Production of fertilizers and potable water from oceanic resources may enormously benefit people or nations across the globe. At present, the worldwide consumption of NPK nutrients stands around 180 million tons (ca. USD 120 Billion) growing at a rate of 2-3% per annum, while the worldwide market size of desalination from seawater is about USD 20 Billion, growing at an average annual rate of 9.5%. The top potash importing countries such as USA, China, India, Brazil, France, and Indonesia, also have severe clean water shortages (barring Brazil (however, Brazil has several distillery plants, the waste streams of these plants are known to be rich in potassium), and depend upon seawater desalination to meet their clean water needs. If the methods discussed herein are integrated with the existing desalination plants, these countries could meet ca. 10-15% of their local demand for potash and rapidly grow their desalination industries while becoming self-sufficient with regard to indigenous production of potash. Further, countries like Saudi Arabia, UAE, and Spain with massive desalination plants in operation could potentially export potash based minerals/specialty chemicals, generating additional revenues, if the methods discussed herein are integrated with their existing desalination plants. The co-production of fertilizers and potable water offers powerful socioeconomic benefits, because the fundamental needs of humans (food and water) are met through local production, distribution and consumption, while creating local jobs, eliminating dependency on imports, and offering clean and green environment. Carbon dioxide, an environmental pollutant, could be converted into solid form such that the overall process could be carbon negative.

Methods of processing brine solutions are disclosed herein. The goal is to process the brine solution to remove and recover pure potassium and potassium salts that have a low salt index. The methods of the present invention include contacting the brine solution with an ion exchanger (IE) to bind cations including potassium (K), sodium (Na), calcium (Ca) and magnesium (Mg) with the ion exchanger. The ion exchanger can be contacted with a first eluent solution followed by a second eluent solution comprising ammonium including ammonium carbonates alone or in combination with other ammonium salts to preferentially recover a sodium rich solution followed by recovering a potassium rich solution from the ion exchanger.

In some embodiments, the potassium and sodium species are recovered together using an eluent without varying concentrations, where the solution containing sodium compounds and potassium compounds can be separated through further processing. For example, potassium carbonates and sodium carbonates (i.e. carbonates and/or bicarbonates) have different solubilities, which can be exploited to selective crystallization or separation or purification of the potassium carbonate and sodium carbonates. The recovered potassium carbonate can be processed as described herein to be dried and purified or reacted with additional compounds to form any of the potassium based compounds described herein.

In some embodiments, the ion exchanger can be contacted with a first eluent solution followed by a second eluent solution comprising ammonium carbonates alone or in combination with other ammonium salts (e.g., sulfates, chlorides, phosphates), to preferentially remove or recover potassium cations from the ion exchanger thereby forming a potassium rich salt solution, including potassium carbonate. For example, a potassium carbonate rich solution can be further processed to form an eluent-free potassium rich solution. In these embodiments, the eluent solution comprising ammonium carbonate can be used to preferentially recover sodium ions from the ion exchanger.

Ammonium carbonates can include ammonium carbonate, ammonium bicarbonate, and mixtures thereof. In some embodiments, the ammonium carbonates can be mixed or combined with other ammonium salts, (NH₄)ₙX⁻ⁿ wherein n=net negative charge and X=organic or inorganic anion, for example, ammonium sulfate, ammonium phosphate, ammonium chloride, etc. Potassium carbonates can include potassium bicarbonate, potassium carbonate, potassium hydroxide and mixtures thereof.

The eluent solution comprising ammonium carbonates and second eluent solution comprising ammonium carbonates alone or in combination with other ammonium salts can also be referred to herein as ammoniacal solutions and ammonia strip solutions. In some embodiments, a higher concentration is used in the eluent solution that preferentially removes potassium from the ion exchanger. The first concentration of ammonium carbonates and the second concentration of the ammonium carbonates can each have a weight of the total dissolved salt of about 0.4 wt. % to about 25 wt. %. In some embodiments, the first or second concentration of ammonium carbonates is 0.05M to about 0.75M. In some embodiments, the first or second concentration of ammonium carbonates is above about 1M. In some embodiments, the first or second concentration of ammonium carbonates is about 0.75M-5M. In some embodiments, only a unitary concentration of ammoniacal solution is used instead of first or second concentrations of ammonium carbonates. For example, in embodiments where two eluent solutions are used, the eluent solution that preferentially removes sodium from the ion exchanger can use a lower ammonium carbonate concentration of 0.05M to about 0.75M and the eluent solution that preferentially removes potassium from the ion exchanger, can use a higher ammonium carbonate concentration of 0.75M-5M.

In embodiments where a single eluent solution comprising ammonium carbonate is used, the higher concentration range can be used to recover sodium and potassium ions from the ion exchange material. The sodium and potassium salts can be purified using the methods described herein to evolve off ammonia and carbon dioxide. The sodium carbonate can be separated from the potassium carbonate solution using a combination of thermal and other methods that rely on the respective salts based on the solubility differences between the compounds. In some cases, the sodium and potassium salts can be further separated using 15-crown-5 ether and 18-crown-6 ether, respectively.

The separation of the sodium rich stream and the potassium rich stream allows for potassium materials to be produced with low sodium impurities. Sodium as an impurity is undesirable in a fertilizer composition. In some embodiments, the sodium content of the isolated and purified potassium materials has a sodium impurity level below about 2% and chloride impurity level below about 2%.

Removing ammonium, carbon dioxide, and/or ammonium carbonate from the metal carbonate rich, such as the potassium carbonate rich solution (or any potassium salt solution) can result in forming a relatively pure metal ion rich solution such as a potassium rich solution. In some embodiments, removing ammonium, carbon dioxide, and/or ammonium carbonate includes removing greater than 90% of the ammonium, carbon dioxide, and/or ammonium carbonate. In some embodiments, removing ammonium, carbon dioxide, and/or ammonium carbonate includes removing greater than 95% of the ammonium, carbon dioxide, and/or ammonium carbonate. In some embodiments, removing ammonium, carbon dioxide, and/or ammonium carbonate includes removing greater than 98% of the ammonium, carbon dioxide, and/or ammonium carbonate. The potassium rich solution can be considered as an ammonia-free solution after the removal of ammonium, carbon dioxide, and/or ammonium carbonate. The potassium rich solution or potassium carbonate rich solution has a concentration from about 3 g/L to about 100 g/L. A variety of methods that can be used to separate potassium salts from ammonium carbonate to form the potassium rich solution include thermal, air stripping, steam stripping, sonication, agitation, membrane separation, solvent extraction methods or combinations thereof.

The ammonia-free potassium rich solution can include a variety of different potassium compounds. For example, the salt form of potassium would be potassium carbonate, if the eluent solution used is ammonium carbonate. On the other hand, if the composition of the eluent solution is a combination of ammonium carbonate and ammonium sulfate, the ammonia-free potassium rich solution will be in potassium sulfate form. Therefore, one could generate any form of pure potassium salt by using appropriate amounts of ammonium carbonate along with ammonium salts, NH₄X, wherein X=an organic or an inorganic anion.

In some embodiments, the metal carbonate rich solution, potassium rich carbonate solution, metal ion rich solution, potassium rich solution, and other solutions of potassium based salts such as potassium sulfate, potassium chloride, potassium nitrate, potassium phosphate, etc can be further concentrated. Concentrating the metal carbonate rich solution, potassium rich carbonate solution, metal ion rich solution, potassium rich solution, and other potassium salts can be done using reverse osmosis, forward osmosis, water evaporation, water distillation, multi-stage flash evaporation, multi-effect distillation, multi-stage flash distillation, mechanical and thermal vapor compression, or solvent extraction. In some embodiments, concentrating the metal ion rich solutions or purified potassium salt solutions can be done using forward osmosis with seawater or seawater reject or concentrated seawater or concentrated brine or potassium depleted seawater or ammonium carbonate solutions as draw solutions.

In some embodiments, the potassium carbonate and other potassium rich salt solution can be dried to form a potassium carbonate solid and other potassium salt solids having purity greater than about 80%. The potassium salt solids can have a purity greater than about 90%. The potassium solids can have a purity greater than about 95%. The potassium solids can have a purity greater than about 96%. The potassium solids can have a purity greater than about 97%. The potassium solids can have a purity greater than about 98%. The potassium solids can have a purity greater than about 99%. The potassium carbonate solids can include K₂CO₃ and KHCO₃. In some embodiments, the potassium carbonate solid consists essentially of K₂CO₃. In some embodiments, the potassium solids produced and recovered include one or more of K₂HPO₄, K₂SO₄, KCl, KNO₃, KOH, K₂HPO₄, KH₂PO₄ and K₃PO₄.

The methods described herein can operate at a high efficiency of recovering potassium from the brine solution and a high efficiency of recycling recovered compounds. For example, in some embodiments, ammonia (eluent) used in the process can be recovered at greater than 98% efficiency.

The metal carbonate rich solution such as the potassium carbonate rich solution can be crystallized using a variety of methods. Examples of methods include thermal methods such as cooling, evaporation, vaporization, solar evaporation, vacuum distillation, steam distillation, or use of solvent extraction methods such as anti-solvent methods, sublimation and solvent layering or directional solvents and combinations thereof. In some embodiments, the eluent solution can include additional ammonium salts besides ammonium carbonates. Examples of additional ammonium salts include compounds having the formula: (NH₄)ₙX⁻ⁿ wherein n=net negative charge and X=halides (Cl, Br, I, F), borates, oxides, phosphonates, phosphates, carboxylates, sulfates, sulfonates, carbonates, SO₄, HSO₄, SO₃, S₂O₃, S₂O₇, PO₄, H₂PO₄, HPO₄, OH, SiO₄, NO₃, CO₃, HCO₃, BO₃, B₂O₇, BF₄, CH₃COO, R—PO₃, R—COO, R—SO₃, with R being an organic moiety, and mixtures thereof. The use of the additional ammonia salts can result in the recovery of compounds having the formula KX (wherein X is as described in the above formula) from the processes described herein. For example, the compounds having the formula KX can be recovered from the potassium rich solution. Any of the methods for concentrating the solutions described herein can be used to process the potassium rich solution to recover the compounds having the formula KX from the potassium rich solution. In some embodiments, the recovered compounds include one or more of K₂HPO₄, K₂SO₄, KCl, KNO₃, KOH, and K₃PO₄. In some embodiments, the recovered compounds can be concentrated to a concentration of about 3 g/L to about 100 g/L. In other embodiments, the compounds can be dried to the salt form.

The metal carbonate rich solution, potassium carbonate rich solution, metal ion rich solution, and potassium rich solutions described herein can undergo additional processing including contact with one or more of organic or inorganic acids, metal salts, metal oxides, metal hydroxides to form one or more potassium salts beside potassium carbonates. For example, the potassium carbonate rich solution and potassium rich solutions described herein can be contacted with any of the following compounds: organic or inorganic acids (HₙX⁻ⁿ), metal salts (MₙX⁻ⁿ), metal oxides, metal hydroxides to form one or more potassium salts beside potassium carbonates, wherein X=halides, borates, oxides, phosphonates, phosphates, carboxylates, sulfates, sulfonates, carbonates, SO₄, SO₃, PO₄, H₂PO₄, HPO₄, OH, SiO₄, NO₃, CO₃, HCO₃, BF₄, CH₃COO, R—PO₃, R—COO, R—SO₃, HSO₄, SO₃, R=an organic moiety. Contacting the ammonium carbonate containing potassium rich solutions with the above compounds leads to the formation of relatively pure compounds or solutions having the formula KX. The compounds having the formula of KX can be recovered and concentrated using any of the methods described herein. Any of the methods for concentrating solutions described herein can be used to process the potassium rich solution to recover the compounds having the formula KX from the potassium rich solution. In some embodiments, the recovered compounds include one or more of: KH₂PO₄, K₂HPO₄, K₂SO₄, KNO₃, KOH, and K₃PO₄. In some embodiments, the recovered compounds can be concentrated to a concentration of about 3 g/L to about 100 g/L. In other embodiments, the compounds can be dried to the salt form.

Any of the ammonium carbonate streams described herein can be processed to recover ammonia as gaseous ammonia and carbon dioxide as gaseous carbon dioxide. The recovered gaseous ammonia can be recycled with additional processing to form ammonium carbonate that can be used in a solution form to contact the ion exchanger to preferentially remove ions on the ion exchanger. The recycling efficiency of ammonia generated is greater than 90%. The recycling efficiency of ammonia generated can be greater than 95%. The recycling efficiency of ammonia generated can be more than 98%. The ammonia generated can be recycled with efficiency, above 99%. The recovered gaseous carbon dioxide can be recycled with additional processing to form an ammonium carbonate that can be used in a solution to contact the ion exchanger to preferentially remove ions on the ion exchanger. For example, the gaseous ammonia and carbon dioxide can be reacted together to form ammonium carbonate. Any additional carbon dioxide needed can be obtained from industrial or natural resources.

Sodium rich streams can be recovered and disposed of, by sending them back to the brine source, such as the body of water or seawater. Ammonia can be removed/ recovered from any ammonium laden brine solution using the carbonates in the sodium rich stream prior to disposing of the remainder of the sodium rich streams. It may be noted that in the present invention, the volume average ammonia values are brought down to below 50 ppm, or below 20 ppm, while typically the volume average ammonia values are above 1000 ppm. The ammonium laden brine solutions are either seawater or seawater reject or concentrated seawater or NaCl enriched seawater or saturated solution of NaCl either in water or seawater.

The recovery of ammonia and carbon dioxide from the ammonium laden streams in the process is accomplished by using the sodium rich streams. In one of the embodiments, sodium rich streams are added to the ammonia laden salt solutions to recover ammonia and carbon dioxide. In one of the embodiments, bases such as lime or slaked lime or sodium carbonate or sodium hydroxide are added alone or in combination to increase the pH and evolve/recover ammonia.

The brine solution can be from deep brines in sedimentary basins, shallow ground water brines, saline or dry lakes, geothermal brines, potash mines, brackish water, waste stream from distilleries, inland oceans, seawater or seawater bittern or reject from desalination plants. In some embodiments, the brine solution is produced by a desalination process. The desalination process can produce the brine solution using one or more of the membrane based technologies such as reverse osmosis, forward osmosis, electro-dialysis and ultra-filtration; thermal based technologies such as multi-stage flash evaporation, multi-effect distillation, multi-stage flash distillation, mechanical and thermal vapor compression and nano filtration or chemical based solvent extraction processes.

The methods can include processing the potassium carbonate rich solution, purified potassium carbonate solution, potassium rich solution, and other process streams to produce a fertilizer composition. In some embodiments, the potassium carbonate rich solution comprises one or more of phosphorous, nitrogen, sulfur, calcium, magnesium, boron, chlorine, manganese, iron, zinc, copper, molybdenum and nickel. In some cases one or more of phosphorous, nitrogen, sulfur, calcium, magnesium, boron, chlorine, manganese, iron, zinc, copper, molybdenum and nickel can be added to the potassium carbonate rich solution or potassium rich solution to achieve the desired fertilizer composition.

The methods described herein can include selecting a distinct fertilizer composition and adding one or more of phosphorous, nitrogen, sulfur, calcium, magnesium, boron, chlorine, manganese, iron, zinc, copper, molybdenum and nickel to the potassium carbonate rich solution or potassium rich solution to achieve the distinct fertilizer composition. The distinct fertilizer is selected from the group consisting of NK, PK, and NPK fertilizers. In some embodiments K, NK, PK, NPK or NPKS fertilizers can be produced in solid or liquid form.

The methods can include addition of additional components to the fertilizing composition. In some cases, the methods can include the addition of one or more of pesticides, insecticides, fungicides, herbicides, organic extracts, and natural extracts, to the fertilizing composition.

The methods can also include the addition of a nitrogenous source to the potassium carbonate rich solution, purified potassium carbonate solution, potassium rich solution, or the fertilizer composition selected from the group consisting of urea, nitric acid, ammonium chloride, ammonium nitrate, ammonium sulfate, ammonium phosphite, ammonium phosphate, ammonium hydroxide, ammonia, calcium cyanamide, calcium nitrate, and sodium nitrate.

The methods can also include the addition of a phosphorous source to the potassium carbonate rich solution, purified potassium carbonate solution, potassium rich solution, or the fertilizer composition selected from the group consisting of naturally mined phosphorous minerals, metal phosphates, apatites, phosphoric acid, pyrophosphate, orthophosphates, polyphosphates, alkaline phosphates, alkaline earth phosphates, diammonium phosphate, and calcium based phosphates.

In some embodiments, the methods include addition of a plant micronutrient such as boric acid or sodium borate, sodium molybdate, chelated micronutrients to Zn, Fe, Cu, Mo and the like to the potassium carbonate rich solution, purified potassium carbonate solution, potassium rich solution, or the fertilizer composition.

In some embodiments, the methods include contacting the potassium carbonate rich solution, the purified potassium carbonate solution, potassium rich solution, with one or more of: phosphoric acid, nitric acid, phosphorous rock, rock phosphate, calcium phosphates, ammonium phosphates, urea, calcium hydrogen phosphate/calcium apatite or phosphoric acid or nitric acid or sulfuric acid or sodium carbonate and bicarbonate or calcium hydroxide to obtain CaCO₃ or H₃PO₄ or NaOH or NH₄OH or CaHPO₄ or phosphates of sodium and potassium to produce a NK, PK, and NPK fertilizers.

In some of the embodiments, low salt index potassium salts (≤70) are generated directly from the brine solution.

The ion exchanger can include a material selected from the group consisting of: inorganic or organic or hybrid particulate materials that have binding affinity towards potassium ions.

Although, the present disclosure focuses on seawater as a source for directly producing a variety of potassium minerals besides potassium chloride, it can readily be applied to any brine/salt solution comprising potassium ions. Some of the examples of natural or industrial resources for extracting potassium include, brine solutions from potash mines, inland oceans, brackish water, seawater bitterns, seawater, seawater reject from desalination, salt lakes, salt mines, geothermal brines, deep brines in sedimentary basins, shallow ground water brines associated with saline or dry lakes, waste streams from distillery plants or any other mining plants and from organic sources. Further, seawater reject from desalination methods can be further processed using reverse osmosis, forward osmosis, water evaporation, water distillation, multi-stage flash evaporation, multi-effect distillation, multi-stage flash distillation, mechanical and thermal vapor compression, advanced vapor compression desalination, and solvent extraction. Any desalination method that can produce two distinct concentrations of seawater reject or provide desalination efficiencies ranging from 35% to 75% that may offer additional advantages for the potassium extraction processes are described herein. Brine is typically a high concentration of salt in solution i.e., water (typically salt solutions with concentrations ranging above 1.0% to saturation limits. However, the innovation proposed here is capable of recovering potassium from salt solutions that has concentration less than 1.0%).

Phosphates, carbonates, sulfates etc. as used herein can represent all the possible chemical and ionic forms involving metal ions. Pure or highly pure potash salts can refer to or imply that at least about 80% of the metal ions present in the solution are potassium and the rest of the impurities are made of other cations (excluding anions). It is to be noted that, purities can also be expressed in terms of percentage purity, where the percent ratio is calculated between the mass of useful product to the total mass of sample. Alternatively, in conditions where the mixture of potassium salts are recovered from the ion exchange (IX) media or prepared, the purity of each individual salt in the composition can be expressed as % purity based on its proportion with the total mass of the mixture or solution. For example, if a solution or a solid is made of potassium carbonate and potassium sulfate, in 50:50 weight ratio, the percentage purity of potassium carbonate is 50%, while the percentage purity of potassium sulfate is also 50%. A potassium purity of 99% can refer to a composition with only 1% or less of non-potassium cation impurities.

From a fertilizer purity calculation perspective, the potassium values/purities are expressed in terms of K₂O. The K₂O value for KCl is 63%, while for K₂SO₄ and K₂HPO₄, it is 54% and for KNO₃ and K₂CO₃, it is 46.6% and 68% respectively. So, the K₂O value of a fertilizing formulation containing 50:50 potassium carbonate and potassium sulfate is 61%.

The purities of potash salts recovered range from 80% to 99.99%, in the process depending upon the recovery conditions. For some of the fertilizing applications, the K₂O content and salt index are more important than potassium purity percentage, provided the impurities present do not harm the plants and affect the yields.

In other applications, the potassium salts containing identical anions (i.e., no mixture of potassium salts) with high purity may be recovered as specialty chemicals for non-fertilizing application (e.g., use of highly pure potassium carbonate for food industry or as a buffering agent). Multiple grades of high purity potassium salts and mixtures of potassium salts can be produced for different applications and purposes.

The simplified process flow diagram of recovering potassium from seawater or any brine solution containing potassium is given in FIG. 1. Pretreated seawater 100 via line 101 is pumped 102 through a line 103 for the desalinating reverse osmosis (RO) unit 104 with a reverse osmosis membrane. The reverse osmosis membrane desalinates the seawater, and a seawater reject stream 105 is pumped 106 through line 107 into seawater reject storage tank 108. Clean water generated from the battery of RO membranes is carried through lines 109 and 111 through pump 110 to a storage unit 112. Part of the clean water can be used for processing fertilizing compositions.

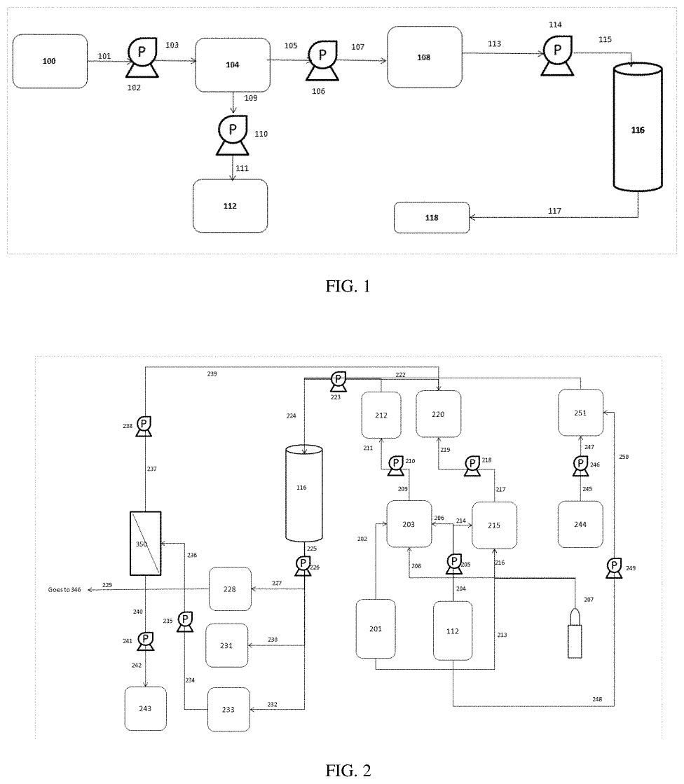

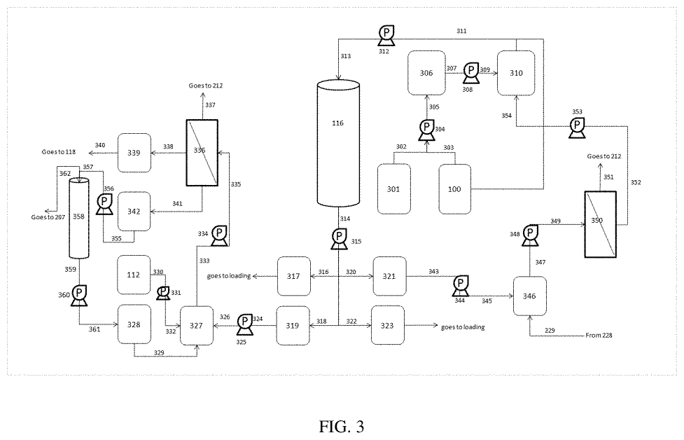

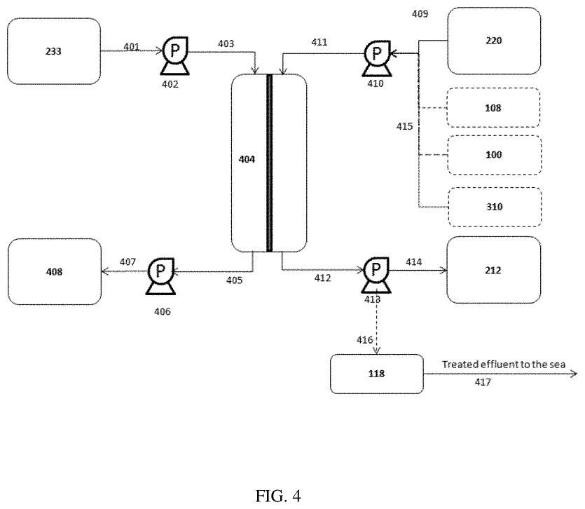

Seawater reject or brine containing potassium 108 is pumped through a feed pump 114 through lines 113 and 115 at flow rates ranging from 2 BV/h to 20 BV/h (bed volumes per hour) into an ion exchange (IX) column 116 packed with one of the potassium specific sorbent materials such as natural inorganic ion exchangers, modified natural zeolites or natural/synthetic Clinoptilolite. Several types of potassium specific ion exchange materials could potentially be used for potassium recovery such as clays, vermiculate, carbonaceous material; synthetic zeolite W, synthetic crystalline silicotitanate, niobium-substituted silicotitanate, synthetic micas, and synthetic tin antimonates, p-zeolite, zirconium silicates, titanates, transition metal hexacyano ferrates; synthetic organic ion exchangers i.e., resins (cross linked polystyrene, phenolics, acrylics); organic-inorganic hybrid of potassium specific adsorbents, especially made of Clinoptilolites, or silicotitanates, and homogenous and heterogeneous ion exchange membranes. Typically, the ion exchange materials exist in fine particulate form and may need to be agglomerated using polymeric or inorganic binders or in some instances, naturally mined ion exchange materials are chemically and physically modified, i.e., heat treated, or coated, or agglomerated to further improve their physical and chemical properties such as loading capacities and crush strength. Some IX materials preferentially/selectively adsorb potassium while also adsorbing certain amounts of mono and divalent ions less preferentially. The potassium depleted seawater is passed into effluent treatment unit 118 through a line 117. The effluent stream may be further treated if it contains any unwanted chemicals above certain defined concentration just to ensure that the stream introduced back into the ocean meets all the regulatory and environmental compliance requirements. Once the potassium reaches the breakthrough point of loading onto the IX material in the column 116, it can be removed. It was also found that the potassium capacity of the sorbent could be increased once the IX material in column 116 is fully loaded with potassium, by stripping with eluent/ammoniacal salt solutions of two different concentrations stored in 212 and 220 or an unitary concentration stored in 220 (FIG. 2). At least one of the ammoniacal salt solutions, preferably the higher concentrated solution contains ammonium bicarbonate. As used herein, ammonium bicarbonate, and ammonium carbonate can be referred to interchangeably and loosely imply a NH₃—H₂O—CO₂ system, which contains various ionic species in equilibrium, although the ratio of each species depends on the molar ratios of ammonia, carbon dioxide and water, and other experimental conditions unlike in the solid state. For example, the CO₂—NH₃ (CO₂ from environment could be used as a source for this potassium recovery, making potassium recovery process carbon negative) system undergoes hydrolysis in water resulting in a number of ionic species such as H⁺, OH⁻, NH₄⁺, NH₂COO⁻, HCO₃⁻, CO₃²⁻, in various amounts, due to experimental/operational/kinetic conditions and speciation. Therefore, it should be appreciated that the strip solution can include ammonium carbonate or ammonium bicarbonate, which is preferred, or a mixture of ammonium carbonate and bicarbonate interchangeably acknowledging the possible existence of related anionic/cationic species of this system, as the equilibrium conditions govern the relative proportion of these species in the solution. Also, a positive pressure of air, CO₂, NH₃, nitrogen or any other gas can be used to stabilize some of the aforementioned ionic species in the liquid form. The pH of the ammonium carbonate system is maintained between 6 and 10, preferably between 7 and 9. The pH of ammonium bicarbonate and ammonium carbonates are 7.6-7.8 and about 8.6, respectively. Additional organic or inorganic anions, X, may be used in the form of (NH₄)ₙX⁻ⁿ (where n is the net charge of anion, for example X=halides, borates, oxides, phosphonates, phosphates, carboxylates, sulfates, sulfonates, carbonates, SO₄, SO₃, PO₄, H₂PO₄, HPO₄, OH, SiO₄, NO₃, CO₃, HCO₃, BF₄, CH₃COO, R—PO₃, R—COO, R—SO₃, HSO₄, SO₃, R=organic moiety) to the NH₃—CO₂—H₂O—X system. For example, ammonia under these conditions typically acts as an ammonium cation, while carbonates and anion X together act as counter ions to maintain neutrality. The advantage of using the NH₄—CO₃—X—H₂O system is that, one could produce various KₙX⁻ⁿ salts directly as products by fine-tuning the ratio of this system as the eluents. The concentration of the ammonium salts in the stripping solution was varied to ensure the separation of contaminants such as sodium, calcium and magnesium from potassium during the recovery. The presence of sodium in fertilizer compositions is unwarranted and detrimental to plant health and can prevent the generation of high purity potassium minerals from seawater. Alternatively, sodium carbonate and potassium carbonate were recovered from the ion exchange material by using unitary concentration, preferably higher ammonium carbonate concentration ranges of the eluent solution. A pure solution of potassium carbonate can then be obtained by thermal and solubility variable studies as well as the use of specific crown ethers to separate sodium from potassium salts.

In some embodiments, the preferred concentrations of ammoniacal salt solutions range from 0.05 to about 5M. Lower concentrations of ammoniacal salts with concentrations below 0.75M tend to selectively strip unwanted impurities such as sodium, calcium and magnesium. High purity potassium was recovered using a high concentration of ammonium salts, NH₄—HCO₃—X or NH₄—CO₃—X, where X is any organic or inorganic anion that balances the overall charge of the ammoniacal salts to complement the stoichiometric ratio of bicarbonate anions present in the system. Depending upon the anion X, the final potassium product will assume K—HCO₃—X or K—CO₃—X, K—OH—X, where the charge neutrality of the salt is maintained by complementing the molar ratio of hydroxides/carbonates with X. The product containing K—NH₄—CO₃—X or K—NH₄—HCO₃—X can be stripped of ammonium carbonates to form pure KX or KHCO₃ or K₂CO₃ salts. For example, if X=H₂PO₄, SO₄, NO₃, OH, then, pure KH₂PO₄, K₂SO₄, KNO₃, and KOH salts can be generated, respectively. If X is identical to CO₃ or HCO₃, then a pure KHCO₃ or K₂CO₃ salt solution can be generated. KHCO₃ can be converted to K₂CO₃ or vice versa, by adding or removing carbon dioxide from the system. Pure potash salts can be generated with a mixture of anions, for example, potassium bicarbonate or carbonates could co-exist with hydroxides or phosphates or nitrates. The ability to generate pure potash salts with a mixture of anions can be extremely important for generating fertilizer compositions of low salt index as foliar sprays or fluid fertilizers (e.g., potassium carbonate-potassium citrate mixture) or NPK formulations. The concentration of the first potassium strip solution is preferably greater than about 0.75M. The preferable second concentration of the potassium strip solution is above about 0.5M and preferably above about 1M.

As seen in FIG. 2, the ammonium bicarbonate solution from storage tank 201 is pumped into mixer 203 through line 202 where RO water from 112 is drawn into mixer 203 via lines 204 and then pumped through feed pump 205 via line 206 into mixer 203 to prepare ammonium strip solution with the desired lower concentrations Similarly, a higher concentration of strip solution is prepared in mixer 215 by drawing water from 112 via line 204 and 214 along the feed pump 205 with the ammoniacal salt drawn from 201 via line 213. In addition, in one of the embodiments, carbon dioxide gas from storage tank 207 is passed into the mixers 203 and 215 via lines 208 and 216 during the preparation of ammonium based salt solution that are used to strip contaminants and potassium. The ammonium salt solution of required concentration is pumped through lines 209 and 211 using the pump 210 to a storage tank 212. Alternatively, the second concentration is pumped through lines 217 and 219 via pump 218 into storage tank 220. The strip solutions are passed onto IX column from their storage tanks 212 and 220 via lines 222 and 224 along the pump 223. Additionally, if needed, the potassium adsorbed by the IX material can be recovered using salts other than ammonium bicarbonate or in combination by storing alternative ammonium salts like (NH₄)ₙX⁻ⁿ solutions stored in storage tank 244. The stripping solution is made by drawing water from 112 using lines 248 and 250 via pump 249 into storage tank 251 wherein the desired concentration of the salt solution can be prepared with appropriate dilution of the salt drawn from storage tank 244 via pump 246 using lines 245 and 247.

In one of the preferred embodiments, sodium and potassium rich solutions stripped from the IX column 116 are collected in tanks 228, 231 and 233 through lines 227, 230 and 232 respectively. These solutions are pumped into respective storage tanks using pump 226 via line 225. The eluent solution of storage tank 231 that is rich in sodium is however contaminated with ammonium and related anions from the ammonium salts used for stripping potassium ions. This strip solution is sent to effluent treatment tank 118 and sent back into the sea or passed on to the IX media and then back to the sea. It is to be noted here that more than one IX media column can be used in commercial operations to efficiently extract and recover pure potassium minerals to increase throughput and reduce idle time of the column operation. In embodiments that use multiple IX media columns, the IX medial columns can be in series, in parallel, or a combination of parallel and series.

The potassium rich salt solution containing ammonium carbonates from the IX column 233 is pumped via line 234 through the feed pump 235 into a reactor 350 via line 236. The potassium rich salt solution containing ammonium carbonates can be purified by removing ammonia and carbon dioxide at room temperature or at elevated temperature through agitation, air stripping or steam stripping. The stripping of ammonia and carbon dioxide can be accelerated at temperatures ranging from 40° C. to 120° C. using a variety of thermal sources, including just air or hot air or steam. The ammonia and carbon dioxide evolved from the reactor 350 is further processed to recover ammonia and carbon dioxide gases as ammonium bicarbonate or carbonate. The pure potassium carbonate solution or mixture of potassium carbonate with other potassium salts or a pure KX salt solution without potassium carbonate is collected into storage tank 243 via lines 240 and 242. through the pump 241. The evolved gases are captured into strip solution storage 220 via lines 237 and 239 using the feed pump 238. The high purity K₂CO₃ or other pure potassium salt products 243 can be further concentrated by thermal methods or solar evaporation (5 to 25 times) or by the use of membrane based reverse and forward osmosis methods described in FIG. 4.

The product cut containing potassium and ammonium carbonates may directly be treated with a variety of acids leading to the formation of fertilizer compositions. The stoichiometric addition of acids can be controlled to selectively generate potassium salts while liberating ammonium and carbon dioxide. Also pure potassium carbonate could be obtained by thermal treatment and under positive pressure from carbon dioxide of the carbonates of potassium and ammonium to recover NH₃ and generate back more than 99.5% of NH₃ and ammonium bicarbonate solution. Also, the pure potassium carbonate may be treated with different organic and inorganic acids to obtain various potash salts in pure form liberating carbon dioxide that can be captured efficiently and reused. Some exemplary possibilities of the current methods leading to the generation of a range of potash salts and evolution of ammonia and/or carbon dioxide are as shown:

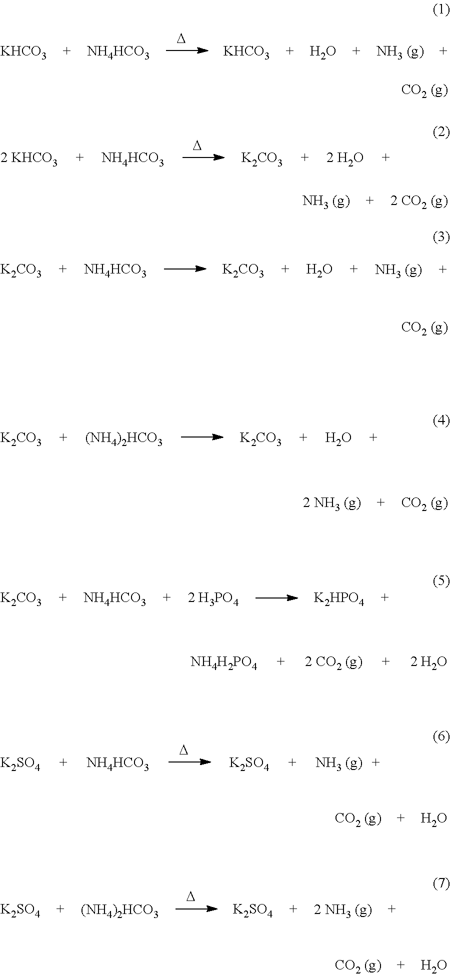

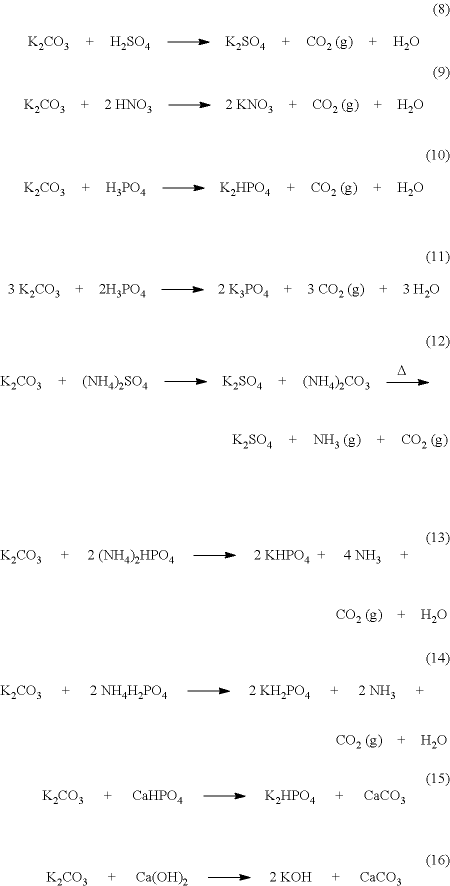

The ammonium salts that arc left adsorbed onto IX material in the column are recovered for the purpose of recycling. The saturated NaCl solution from storage tank 301 and seawater from 100 are pumped 304 via lines 302 and 303 into mixer 306 via line 305. The seawater is enriched with the salt solution and passed through a line 307 through the pump 308 into storage tank 310 via line 309. This solution is directed into IX column via lines 311, 313 and feed pump 312. The sodium ion concentration in the seawater enriched with salt can range from 10,000 ppm to as high as 100,000 ppm or a saturated solution, most preferably around 60,000 ppm. Further, the seawater concentrated several fold, i.e., 5-10 times (using solar energy or through solar evaporation) could be used to recover ammonia from the column. Any salt solution containing high ionic strength could also potentially be used to flush out ammonium ions from the column to regenerate it for subsequent recovery of potassium ions. The recovery of ammonium ions from the IX column 116 is completed upon passing seawater 100 via lines 311 and 313 using the feed pump 312. A line 314 containing the ammonia rich solution is sent to ammonia recovery units or storage tanks 317, 319, 321, and 323 via lines 316, 318, 320 and 322, respectively. The ammonium recovery from the storage tank 319 is optionally treated with a lime slurry by passing lime 328 via line 329 and RO water 112 via lines 330 and 332 into mixer 327. This mixture is pumped 334 via lines 333 and 335 into reactor 336 to recover ammonia gas. The recovered ammonia gas at high temperature and pH conditions is passed along the line 337 into storage tank housing ammonium strip solution 212. The ammonia-free solution 339 is then directed towards effluent treatment tank 118 via line 340 for ejecting the solution into the sea. In this illustrated process of recovering ammonia with the addition of lime, calcium carbonate 342 was obtained as by-product. Calcium carbonate under temperatures of 500-600° C. is allowed to disassociate into lime and carbon dioxide, both of which are valuable raw materials that can be reused in the process. Calcium carbonate slurry 342 is pumped 356 and filtered before subjecting it to high temperature reactor maintained above 500° C. 358 via lines 355 and 357 wherein CaCO₃ is disassociated into lime and carbon dioxide. The lime is collected in storage tank 328 via pump 360 and lines 359 and 361. The evolved carbon dioxide is recovered back into carbon dioxide storage tank 207 via line 362. However, it is possible to eliminate the usage of lime and evolve ammonia using sodium carbonates.

The ammonia recovery solution 321 is pumped 344 into a mixer 346 via lines 343 and 345. Before passing this solution into the reactor operated at high temperatures, sodium strip solution 228 via line 229 can be optionally allowed to mix with the ammonia rich solution and this mixture is pumped into the reactor 350 via lines 347 and 349 and feed pump 348. The ammonia gas evolved is captured by the strip solution 212 via line 351. The ammonia-free solution is re-looped into the process by pumping the seawater enriched with salt solution (storage tank 310) via lines 352 and 354.

The potassium salts recovered from the IX sorbent are concentrated using a forward osmosis method where the draw solution is the recovered or rejected solution of the process. The forward osmosis based desalination method could be used for concentrating the potassium rich product cut solution over the others for two main reasons, it is a low energy intense process, and the draw solution used to concentrate potassium solutions is readily available as part of the process. The seawater or seawater reject or potassium depleted seawater or any source of concentrated seawater could be used as draw solution to concentrate potash salt solution. The other potential draw solution includes the use of high concentration ammonium carbonate. The ammonium bicarbonate draw solution could extract water from the potassium rich product solution across a semi-permeable polymeric membrane. High osmotic pressure generated by a highly soluble ammonium bicarbonate solution yields high water fluxes and can result in very high feed water recoveries. In the process as described herein, ammonium carbonate does not need to be recovered to generate pure water; instead a diluted form of ammonium carbonates can be used as an eluent to strip sodium and potassium ions from the column. Concentrating the product using forward osmosis integrates into the overall process of extracting high purity potassium salts. The concentrated product can be further crystallized by thermal and related methods.

FIG. 4 describes the process flow of integrating forward osmosis into the potassium extraction process, The high purity potassium product cut from the storage tank 233 is pumped 402 through lines 401 and 403 into the forward osmosis chamber/reactor 404 as a dilute feed solution and recovered as a concentrated product through line 405 and 407 via pump 406 into concentrated product storage tank 408. On the flip side of the membrane, the draw solution that facilitated concentration of the product is the ammonium bicarbonate solution recovered from the product 220 of the previous cycles that is passed into the FO chamber via pump 410 and lines 409 and 411. The water drawn from the dilute, potassium solution dilutes the draw solution to obtain the diluted ammonium bicarbonate solution that can be used to strip sodium from the IX material. The diluted draw solution was looped back to storage tank 212 via pump 413 and lines 412 and 414. The other possible draw solution is seawater reject 108 from any desalination. method or seawater 100 or salt infused high concentration seawater 310 or potassium depleted seawater or solar energy concentrated seawater or any of these solutions that can be used as draw solutions (lines 415, and 411 via pump 410) and once the product is concentrated, the diluted seawater reject or brine can be discharged to the sea as seawater effluent 417 after effluent treatment in storage tank 118 via pump 413 and lines 412 and 416.

### EXAMPLES

### Example 1

Recovery of potash from seawater in the form of potassium carbonate: Pure potassium carbonate solution and solids have been made by selectively recovering potassium from seawater sources in combination with carbon dioxide. Seawater or seawater reject (prepared assuming RO efficiency of 35%) was passed into a glass/acrylic column (height 100 cm; id 4.4 cm) at a flow rate of 8-15 BV/h through a 300 g of sodium activated ion exchange media at ambient temperature. The ion exchange media was preferentially loaded with K ions along with other mono and divalent cations such as Na, Ca, Mg, albeit less preferentially. The loaded ions were separated and selectively stripped using distinct concentrations of ammonium bicarbonate solution (0.05M to 2.7M). The potassium ion rich eluents were collected and stored in separate tanks either for further purification or to convert them into various other forms of pure potassium salts or to generate various fortified fertilizing formulations. The ammonium bicarbonate/carbonate from the potassium rich product was removed through simple agitation at room temperature for 10-12 hours. However, the removal was accelerated multiple fold by heating the solution to 80° C. Alternatively, air-stripping or steam stripping or sonication can be used to remove ammonium carbonate from the potassium carbonate/bicarbonate product cut solution. The potassium rich solution was taken in a glass column wound with heating tapes to maintain the temperature of the feed solution at preferably around 80° C. Air was passed from the bottom of the column to agitate the contents and also to push the evolved ammonia and carbon dioxide into the recovery solutions from the top of the glass column. The gases were recovered in water (under positive pressure, while maintaining temperatures below 30° C.) to obtain either a saturated solution of ammonium bicarbonate as a liquid or solid precipitate.

The potassium carbonate solution recovered had only minor impurities of Na, Ca and Mg. The solid weight percentage of potassium carbonate solution ranged from 1.0-3%, and purities ranged between 80-99% depending upon the recovery conditions and concentration limits.

### Example 2

Potassium Carbonate Solids: The liquid potassium carbonate solution of example 1 was concentrated and crystallized to obtain solid K₂CO₃ salt with >95% purity. In one example, 100 mL of potassium carbonate solution was heated to above 100° C. until it formed a saturated solution. The saturated solution was quickly cooled to below 5° C. to crystallize higher purity crystals (>99%) with a high yield. The high purity potassium carbonate crystals were filtered, dried and characterized using ICP-AES, X-ray powder diffraction, and FT IR.

### Example 3

Potassium Sulfate: The potassium ions from a seawater resource were selectively and preferentially recovered from seawater as shown in example 1. However, the potassium from the ion exchange material was eluted using a mixture of ammonium bicarbonate and ammonium sulfate solutions. The differential concentrations of only ammonium bicarbonate at low concentrations followed by a mixture of ammonium sulfate and ammonium bicarbonate was used to strip a pure potassium based mixture of salt solutions comprising potassium-ammonium-carbonates-sulfate-water. The concentrations of ammonium bicarbonate and ammonium sulfate solutions in the mixture used to recover potassium were preferentially in the ratio of 2:1 and the volumes used were in the ratio of 2:1, respectively. The potassium stripped with these solutions was subjected to air stripping at a temperature above 80° C. to remove ammonia and carbon dioxide from the solution mixture leading to high purity potassium sulfate solution of 10-20 g/L, respectively.

### Example 4

Potassium Chloride: The potassium from seawater or seawater reject or any other brine solution was adsorbed on to an IX media as in example 1. The potassium was preferentially recovered using a blend or mixture of ammonium bicarbonate or carbonate or both with ammonium chloride. The concentrations and the volumes of the two stripping solutions used are as described in example 3. The potassium that was preferentially stripped had varied concentrations of sodium contamination that ranged from 3000 ppm to as low as 50 ppm. Thus, a liquid KCl solution was generated by using ammonium chloride as described in example 3 in the place of ammonium sulphate. However, the concentration of ammonium chloride used was twice that of ammonium sulfate to ensure molar equivalence of ammonium cations.

### Example 5

Potassium Phosphate: The loading and preferential recovery of potassium from the IX material is as described in example 1. After eluting Na using the first concentration of ammonium salts, the adsorbed potassium was recovered using either a mixture of ammonium bicarbonate/carbonate with diammonium phosphates described in examples 3 and 4. The potassium salt solution obtained was with ammonium bicarbonate or carbonate that was evolved by heating the solution to higher temperatures. The end solution was potassium phosphate.

### Example 6

Converting Potassium Carbonate to Other Forms of Potassium Salts (K₂SO₄, K₂HPO₄, KNO₃, KCl, Potassium Citrate) using Acids: The potassium carbonate salt solution from example 1 was treated with different acids to produce corresponding potassium salts in pure form. Numerous potassium salts could be generated by adding several acids in different stoichiometric ratios. Potassium sulfate, potassium mono hydrogen phosphate, potassium nitrate, potassium chloride and potassium citrate considering acids H₂SO₄, H₃PO₄, HNO₃, HCl and citric acid were made. The above mentioned acids were added to potassium carbonate solution (50 mL; 10 wt. %) based on the mole-mole ratios of the potassium cation with that of the respective anions from the acids (slightly excess amount of acids were used to ensure full conversion and evolution of carbon dioxide) to form desired potassium salts.

### Example 7

Converting Potassium Carbonate to Other Forms of Potassium Salts (K₂SO₄, K₂HPO₄, KNO₃, Potassium Citrate) using Calcium Minerals: A K₂CO₃ solution can be treated with different metal salts of calcium, magnesium and others to generate soluble potassium salts, which can be readily separated from insoluble by-products. For example, when a K₂CO₃ solution was treated with Ca₂SO₄, or Ca(OH)₂, or Ca₃(PO₄)₂, or Ca₂HPO₄ or Ca(H₂PO₄)₂ to produce K₂SO₄, KOH, or KHPO₄, respectively.

The potassium carbonate solution was concentrated to 10 wt. % of K₂O. A 10 wt. % solution of K₂O was prepared by solubilizing 14.7 g of K₂CO₃ in 100 mL of deionized water. To this solution, CaSO₄ was added stoichiometrically (0.92 g) and the solutions were allowed to stir overnight at room temperature. The supernatant (95 mL) was decanted and the precipitate obtained was dried. The supernatant was pure potassium sulfate solution and the precipitate (4.2 g) was CaCO₃. The salt solutions were crystallized by thermal evaporation. However, the solutions can be concentrated and crystallized using any of the known methods (e.g. solvent extraction, co-crystallization, vapor or solvent diffusion, slow evaporation and slow cooling, and the like).

Akin to the above example, CaSO₄ was replaced with Ca(OH)₂, or Ca₃(PO₄)₂ or Ca₂HPO₄, Ca(H₂PO₄)₂] to produce KOH or KHPO₄, and CaCO₃ and Ca(H₂PO₄)₂ as the by-products (precipitates).

### Example 8

NPK Fertilizers

Method 1: The potassium carbonate solution mixture of example 1 was reacted with di-ammonium phosphate and urea or H₃PO₄ and urea to make NPK fertilizers.

Method 2: The potassium carbonate solutions were treated with CaH₂PO₄, phosphate rocks to generate potassium phosphate solution.

Method 3. A combination of ammonium and potassium carbonate salts were treated with calcium salts to form insoluble calcium carbonate and soluble potassium containing fertilizer compositions.

### Example 9

Liquid Fertilizer compositions: In the process of recovering potassium from the IX media using carbonates or bicarbonates of ammonium either singly or in combination with at least one of the other ammonium based salts as mentioned in the previous examples, liquid fertilizer compositions comparable to the complex mixture compositions available with varied N, K compositions were generated. Some of the N—P—K compositions include 12-0-8; 12-30-12; 0-12-12; 10-10-10; 0-20-10; 0-30-10 etc. The process of the present invention enables preparing a variety of NPKS formulations tailored to crop type and stages of plant growth.

### Example 10

The various N—P—K fertilizers or the liquid fertilizer compositions generated as detailed in Example 8 or Example 9 were additionally supplemented with at least one or more of the plant micronutrients such as B, Cu, Fe, Mn, Zn, Mo. The percent of each of these micronutrients varied with the crop type and the N, P and K compositions. The percent of micronutrient added can range preferentially from 0.01% to 0.5% depending on the soil composition of the arable region and the type of micronutrient. Also, either one or more than one of these micronutrients could be added to the N—P—K and liquid fertilizer compositions depending on the type of crop and the stage of crop development.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as set forth in the claims.

The examples and illustrations included herein show, by way of illustration and not of limitation, specific embodiments in which the subject matter may be practiced. As mentioned, other embodiments may be utilized and derived there from such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

We claim:

1. A method of processing a brine solution, comprising:
contacting the brine solution with an ion exchanger to bind metal cations including potassium (K) and sodium (Na) with the ion exchanger;
contacting the ion exchanger with an eluent solution(s) comprising ammonium carbonates to remove metal cations from the ion exchanger;
recovering a metal carbonate rich solution from the solution eluted from the ion exchanger; and
removing one or more of: ammonia, carbon dioxide, and ammonium carbonates from the metal carbonate rich solution to form a metal ion rich solution.

2. The method of claim 1, further comprising:
contacting the ion exchanger with a first eluent solution comprising an ammoniacal solution having a first concentration of ammonium to preferentially remove sodium cations from the ion exchanger to obtain a sodium rich stream; and
contacting the ion exchanger with a second eluent solution comprising ammonium carbonates to remove potassium cations from the ion exchanger to obtain a potassium rich solution.

3. The method of claim 2, wherein the potassium rich solution is potassium carbonate.

4. The method of any of claims 2-3, wherein the eluent solution has a second concentration of ammonium carbonates, wherein the first concentration is lower than the second concentration.

5. The method of any of the preceding claims, wherein the ammonium carbonates is selected from ammonium carbonate, ammonium bicarbonate, and mixtures thereof.

6. The method of any of the preceding claims, wherein the eluent solution has a first concentration of ammonium carbonates and any other ammonium salts having a weight of total dissolved salt of about 0.2 wt. % to about 50 wt. %, and wherein the eluent solution has a second concentration of ammonium carbonates has a weight of total dissolved salt of about 0.4 wt. % to about 50 wt. %.

7. The method of any of the preceding claims, wherein the first concentration of ammonium carbonates is about 0.05M to about 0.75M.

8. The method of any of the preceding claims, wherein the eluent solution has a second concentration of ammonium carbonates is about 0.75M to about 5M.

9. The method of claim 1, further comprising:
contacting the ion exchanger with an eluent solution comprising ammonium carbonates having concentration in the range of 0.7 to 7 M to recover the metal cations from the ion exchanger;
removing one or more of: ammonia, carbon dioxide, and ammonium carbonate from the metal carbonate rich solution to form a metal ion rich solution.
and crystallizing the metal carbonate rich solution selectively to separate potassium carbonates/bicarbonates and sodium carbonates/bicarbonates from each other.

10. The method of any of the preceding claims, wherein the potassium ion rich solution has concentration from about 3 g/L to about 100 g/L.

11. The method of the preceding claims, further comprising a zero waste/effluent process, wherein the ammonium ions from the effluent stream are removed using the metal carbonates generated in the process to inject the discharge stream back into a salty body of water.

12. The method of any of the preceding claims, further comprising the removal of one or more of ammonia, carbon dioxide, and ammonium carbonate from the metal carbonate rich solution, using a method selected from thermal, air stripping, steam stripping, sonication, agitation, membrane separation, solvent extraction methods or combinations thereof, to obtain the metal ion rich solution.

13. The method of any of the preceding claims, further comprising: concentrating the metal ion rich solution using a process selected from reverse osmosis, forward osmosis, water evaporation, water distillation, multi-stage flash evaporation, multi-effect distillation, multi-stage flash distillation, mechanical and thermal vapor compression, or solvent extraction

14. The method of claim 13, further comprising: concentrating the metal ion rich solution using forward osmosis with seawater or seawater reject or concentrated seawater or concentrated brine or potassium depleted seawater or ammonium carbonate solutions, as draw solutions.

15. The method of any of the preceding claims, wherein the metal ion rich solution comprises a potassium rich solution, and further comprising: drying the potassium rich solution to obtain potassium carbonate having a purity greater than about 80%, or preferably having purity greater than 90%

16. The method of any of the claims 2-15, wherein the first eluent solution comprising ammonium further comprises at least one additional ammonium salt having the formula: (NH₄)ₙX⁻ⁿ wherein n=net negative charge and X=an inorganic or organic anion (Cl, Br, I, F, borates, oxides, phosphonates, phosphates, carboxylates, sulfates, sulfonates, carbonates, SO₄, HSO₄, SO₃, S₂O₃, S₂O₇, PO₄, H₂PO₄, HPO₄, OH, SiO₄, NO₃, CO₃, HCO₃, BO₃, B₂O₇, BF₄, CH₃COO, R—PO₃, R—COO, R—SO₃, with R being an organic moiety, and mixtures thereof).

17. The method of claim 16, further comprising: removing ammonia and carbon dioxide from the potassium rich solution to recover compounds having the formula KX, wherein X=an inorganic or organic anion (Cl, Br, I, F, borates, oxides, phosphonates, phosphates, carboxylates, sulfates, sulfonates, carbonates, SO₄, HSO₄, SO₃, S₂O₃, S₂O₇, PO₄, H₂PO₄, HPO₄, OH, SiO₄, NO₃, CO₃, HCO₃, BO₃, B₂O₇, BF₄, CH₃COO, R—PO₃, R—COO, R—SO₃, with R being an organic moiety, and mixtures thereof).

18. The method of any of the preceding claims, further comprising: contacting the metal carbonate rich solution or the metal-ion rich solution with one or more of organic or inorganic acids, metal salts, metal oxides, metal hydroxides, to form one or more N—P—K fertilizing chemicals.

19. The method of claims 11-12, wherein the ammonia generated is contacted with a carbonate source under reaction conditions selected to obtain ammonium bicarbonate.

20. The method of claim 19, further comprising: contacting the gaseous ammonia from the metal carbonate rich solution with an aqueous or acid source under reaction conditions selected to obtain a recovered salt comprising ammonium salt.

21. The method of claims 19-20, further comprising: recycling the recovered ammonium salt solution to contact the ion exchanger.

22. The method of claim 21, further comprising: adjusting the concentration of the ammonium salt solution to form a first recovered eluent solution and contacting the first recovered eluent solution to preferentially remove sodium cations from the ion exchanger and form a sodium rich solution.

23. The method of claim 22, further comprising: adjusting the concentration of the ammonium bicarbonate and any (NH₄)ₙXⁿ or combinations thereof to form a second recovered eluent solution, and contacting the second recovered eluent solution to preferentially remove potassium cations from the ion exchanger, to obtain a potassium carbonate or KX rich solution, where n=net charge of anion, X=anion and X=Cl, Br, I, F, borates, oxides, phosphonates, phosphates, carboxylates, sulfates, sulfonates, carbonates, SO₄, HSO₄, SO₃, S₂O₃, S₂O₇, PO₄, H₂PO₄, HPO₄, OH, SiO₄, NO₃, CO₃, HCO₃, BO₃, B₂O₇, BF₄, CH₃COO, R—PO₃, R—COO, R—SO₃with R being an organic moiety, and mixtures thereof.

24. The method of any of the preceding claims, further comprising: processing the metal carbonate rich solution, the metal ion rich solution, or potassium rich solution to produce a fertilizer composition.

25. The method of any of the preceding claims, wherein the metal carbonate rich solution comprises one or more of: phosphorous (P), nitrogen (N), sulfur (S), calcium (Ca), magnesium (Mg), boron (B), chlorine (Cl), manganese (Mn), iron (Fe), zinc (Zn), copper (Cu), molybdenum (Mo) and nickel (Ni).

26. The method of any of claims 24-25, further comprising: adding one or more of primary and secondary macro- and micro-nutrients including at least one nutrient selected from phosphorous, nitrogen, sulfur, calcium, magnesium, boron, chlorine, manganese, iron, zinc, copper, molybdenum and nickel, and other additives selected from pesticides, insecticides, fungicides, herbicides, organic extracts, and natural extracts, to the fertilizing composition

27. The method of claim 26, wherein the distinct fertilizer formulation is selected from the group consisting of: K, NK, PK, KS, NPKS, and NPK fertilizers.

28. The method of any of the preceding claims, wherein the potassium ion selective ion exchanger includes a material selected from the group consisting of: inorganic or organic or hybrid particulate materials, particulate materials that are coated or agglomerated with polymeric or inorganic binders/cross linkers, or heat treated particulate materials.

29. The method of any of the preceding claims, further comprising: contacting the metal carbonate rich solution, metal ion rich solution, or the potassium rich solution with one or more of: phosphoric acid, nitric acid, phosphorous rock, rock phosphate, calcium phosphates, ammonium phosphates, urea, calcium hydrogen phosphate/calcium apatite or phosphoric acid or nitric acid or sulfuric acid or sodium carbonate and bicarbonate or calcium hydroxide to obtain CaCO₃ or H₃PO₄ or NaOH or NH₄OH or CaHPO₄ or phosphates of sodium and potassium to produce NK, PK, and NPK fertilizers.

30. A process of selectively recovering potassium salts from a brine source comprising the steps of:
a. selectively and preferentially removing potassium ions from a brine solution by an ion exchange media;
b. treating the ion exchange media using first and second concentrations of ammoniacal salt solutions comprising carbonate or bicarbonate anions, and thereof
c. treating the ion exchange media with a concentrated salt or brine solution, and thereof where a weight of total dissolved salt in the concentrated salt or brine solution ranges from about 3 to about 60 wt %
d. collecting eluates into multiple storage tanks; and
e. either partially or fully recombining, regenerating, recycling, reusing, and re-injecting material from any of the above eluates back into the source to maximize the process efficiency.

31. A method of recovering carbon dioxide from the environment to obtain potassium carbonate comprising the following steps:
a. selectively recovering potassium ions from brine solutions using an ion exchange media;
b. reacting carbon dioxide recovered from the environment with ammonia to form ammonium carbonate or ammonium bicarbonate solution;
c. treating the said ion exchange media with eluents comprising ammonium carbonate solution to recover potassium carbonate; and
d. removing one or more of: ammonia, carbon dioxide, and ammonium carbonate from the metal carbonate rich solution to obtain potassium carbonate rich solution.
